(19) United States
(12) Patent Application Publication
(10) Pub. No.: US 2003/0112866 A1
(43) Pub. Date: Jun. 19, 2003

(54) Method and apparatus for motion detection from compressed video sequence

(76) Inventors: Shan Yu, Evanston, IL (US); Daniel Steward, Hoffman Estates, IL (US)

Correspondence Address: MOTOROLA, INC., 1303 EAST ALGONQUIN ROAD, IL01/3RD, SCHAUMBURG, IL, 60196

(21) Appl. No.: 10/024,886

(22) Filed: Dec. 18, 2001

(51) Int. Cl. H04N 7/12

(52) U.S. Cl. 375/240.03; 375/240.28

(57) ABSTRACT

A receiver locates command data from the compressed video sequence. A detector detects a change in the command data to indicate motion. The detector detects change in the quantization factor to indicate motion according to an embodiment. The receiver locates the command data from the compressed video sequence by obtaining synchronization information to locate known position in the video sequence and by parsing until finding the desired command data field according to an embodiment. This command data located by the receiver indicates the quantization factor of the compressed video sequence. Both the receiver and the detector can operate in real time on the compressed video sequence.

### BACKGROUND OF THE INVENTION

1. Technical Field

The present invention relates to motion detection and, more particularly, relates to motion detection from within a compressed video sequence.

2. Description of the Related Art

Most motion detection techniques from video sequences require analysis of the image in the pixel domain. To perform motion detection, especially in real time, requires considerable processing power. For example, U.S. Pat. No. 6,130,707 issued to Philips, U.S. Pat. No. 6,037,986 issued to DiviCom and U.S. Pat. No. 6,125,145 issued to Sony require much processing power to perform motion detection in the pixel domain.

Another approach is to use special sensors, optical devices and customized circuitry to perform parallel sensing and motion decisions.

What is needed is a real time video motion detector that does not require pixel domain analysis or parallel sensing and decision circuitry.

### SUMMARY OF THE INVENTION

The present invention provides a method and apparatus for motion detection from a compressed video sequence in real time as well as for post-recorded video sequences. It has been discovered that the information in the video header in a compressed video sequence can be used to indicate when motion is taking place and thus reliably perform motion in a quick manner without any significant processing load.

A receiver locates command data from the compressed video sequence. Command data is the processing information typically stored in a video header or the like. The detector locates the quantization factor in the video header information and uses this factor in determining motion. The receiver locates the quantization factor from the compressed video sequence by searching the video sequence for the start of a video frame, typically indicated by a unique code not found elsewhere in the video sequence and parsing until finding the desired quantization factor. Both the receiver and the detector can operate in real time on the compressed video sequence.

The details of the preferred embodiments of the invention may be readily understood from the following detailed description when read in conjunction with the accompanying drawings wherein:

### BRIEF DESCRIPTION OF THE DRAWINGS

FIG. 1 illustrates a schematic block diagram of a video surveillance system having motion detection according to the present invention;

FIG. 2 illustrates a schematic block diagram of the motion detector according to the present invention;

FIG. 3 illustrates a flow chart of the motion detection according to the present invention; and

FIG. 4 illustrates a chart showing the command data of an exemplary video sequence used by the present invention.

### DETAILED DESCRIPTION OF THE PREFERRED EMBODIMENTS

The present invention uses the quantization factors from a compressed video sequence to indicate when there is motion in a video image. Thus motion detection can be achieved from a compressed video sequence without decoding or decompressing the compressed bit-stream in real time.

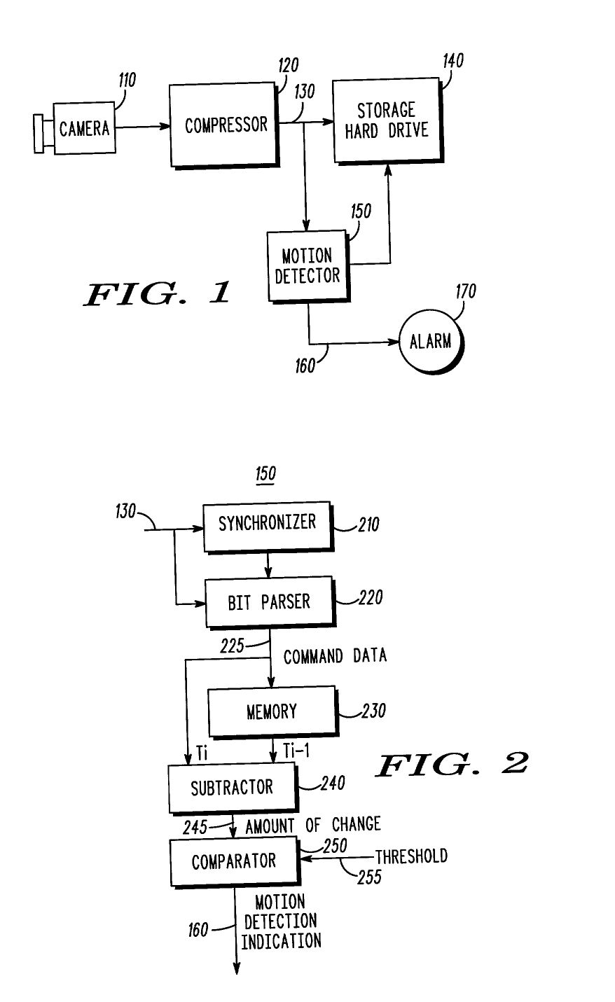

FIG. 1 illustrates a schematic block diagram of a system for receiving and detecting to achieve motion detection, in an otherwise static image, according to the present invention. A camera 110 observes a subject and a compressor 120 outputs a compressed video sequence 130, for either storage to a hard drive 140, or transmission to another device or location. The compressed video sequence 130 output from the compressor 120 is preferably an international video standard such as MPEG1, MPEG2, MPEG4, or H.263. The storage hard drive 140 may be any part of a surveillance or security system for a web site for monitoring various subjects using one or more cameras 110.

A motion detector 150 also receives the compressed video sequence output from the compressor 120. When the motion detector 150 detects motion in the video, a motion indication signal 160 is output. The motion indication signal 160 can be sent, for example, to an alarm 170. Alternatively, the motion indication signal 160 can be used to gate operation of the storage hard drive 140 to save storage space by storing only the video segments with significant motions. The term video covers both rasterized rows and whole screen bit patterns.

FIG. 2 illustrates a schematic block diagram of the motion detector according to the present invention. Synchronization information is obtained from the compressed video sequence 130 by using a synchronizer 210. The synchronizer 210 looks at the compressed video sequence 130 to identify its beginning by finding a starting code. The synchronizer can use a correlator to find this starting code.

A bit parser 220 counts bits since the starting code identified by the synchronizer 210. Once the quantization factor command data is identified, the quantization factor 225 is output to a memory 230 for storage. The succeeding quantization factors 225, Qᵢ, for the succeeding frames are also stored in memory 230. Then, after a next command data 225 is identified by the bit parser 220, a subtractor 240 subtracts the stored command data Tᵢ₋₁ in the memory 230 from the present command data Tᵢ 225. The subtractor 240 performs

$$\frac{{T}_{i} - {T}_{i - 1}}{{T}_{i}} \qquad ( 1 )$$

The present and stored command data Tᵢ₋₁ and Tᵢ are two different samples in time. The samples can be adjacent in time but do not need to be. The amount of change result 245 is produced by the subtractor 240.

Alternative techniques are available for parsing the header portion of the command data besides counting bits since the starting code. For instance each field can be identified and only the quantization factor field used. Counting is preferred because identification of unneeded fields saves processing time.

A comparator 250 compares the result 245 of the subtraction from the subtractor 240 against a threshold 255. The threshold value 255 may be dependent on the bit rate to which the encoder is set. When the result of the subtraction is above the threshold 225, a motion detection indication is 160 output.

Detection of a change in the quantization factor assumes a system having a constant bit rate. The bit rate is the number of bits per second in encoding or compressing the original video sequence. This is not the same as the channel bit rate, which can still be variable, although the encoding bit rate is often the same as the channel bit rate.

The present invention provides a simple way of obtaining the quantization factor without decompressing or decoding is to obtain synchronization information and parse the bit-stream until arriving at the desired command data field.

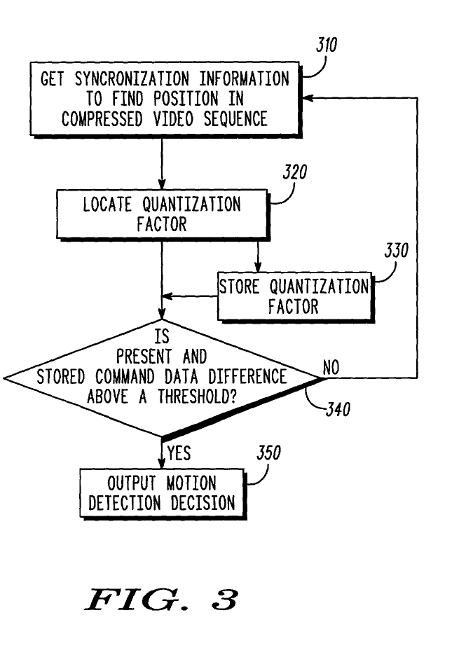

FIG. 3 illustrates a flow chart of the motion detection according to the present invention. Synchronization information is obtained from the video sequence to find a position in the compressed video sequence at step 310. Then, at step 320, the quantization factor is located. The quantization factor is stored at step 330. A difference between the present quantization factor from step 320 and the stored quantization factor from step 330 is obtained in decision step 340. This result is thresholded in step 340 to indicate whether motion detection has been detected. The threshold value may be dependent on the bit rate at which the encoder is running. A motion detection indication is output at step 350 to indicate motion. Otherwise, if the indication was that no motion was detected, it repeats the above steps for a next picture frame.

Specifically, the difference operation performed by step 340 calculates a difference between quantization factors. This difference can be mathematically described as follows on the last n quantization factors, Qᵢ. This operation is

$$\begin{matrix}\frac{{T}_{i} - {T}_{i - 1}}{{T}_{i}} \\ where & ( 2 ) \\ {T}_{i} = {\sum }_{j = i - n}^{i} {a}_{j} {Q}_{j} & ( 3 )\end{matrix}$$

If aᵢ=1, aᵢ₋₁=−1, and aᵢ₋ₙ=0, the resultant equation calculates the percent change in the quantization factor since the last frame.

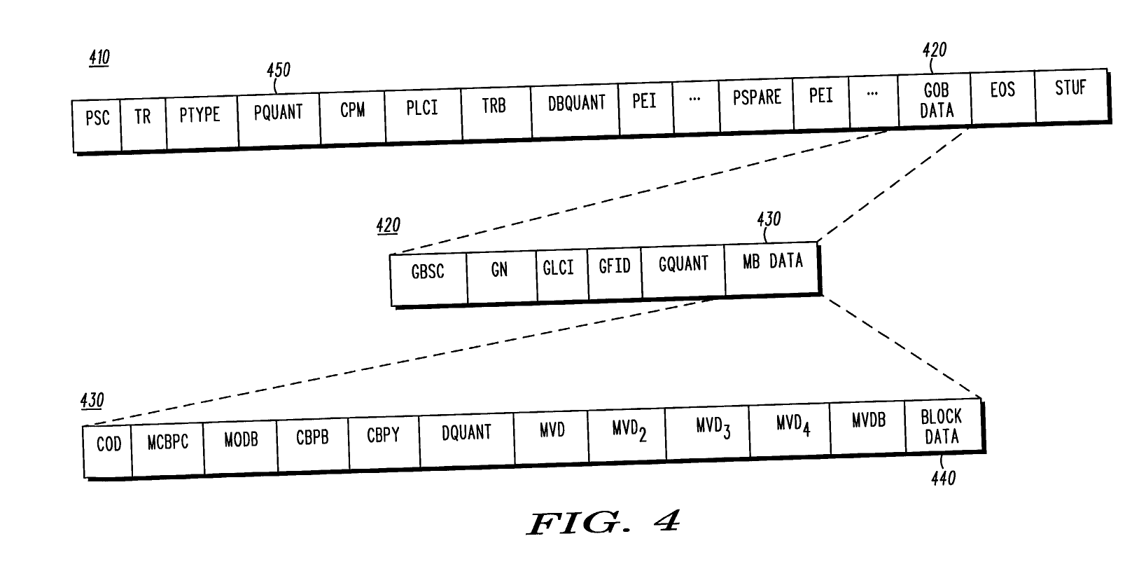

FIG. 4 illustrates a chart showing the frames of an H.263 compressed video sequence used by the present invention. The H.263 video conferencing standard has transmission of video frames 410 containing block data fields 440 and command data fields. The block data fields 440 are large in size relative to the sizes of the command data and contain compressed pixel information for the video image. Within the video frames 410 are GOB DATA fields 420 containing block data and command data fields. Within the video frames 420 making up the GOB DATA fields 420 are MB DATA fields 430 containing block data and command data fields. Within the video frames making up the MB DATA fields 430 are the BLOCK DATA fields 440 and other command data fields. The pixels of the images in a compressed H.263 video stream are stored in the BLOCK DATA fields 440. The prior systems, which analyzed pixel by pixel changes in an image, needed to decompress and decode the frames all the way down to the BLOCK DATA fields 440.

A preferred construction of a H.263 video conferencing detection system uses command data with a quantization factor having a quantization step size PQUANT 450. PQUANT is the step size block in the H.263 international video conferencing standard. Other video standards, such as the international MPEG standards, e.g., MPEG-1, MPEG-2 and MPEG-4, have similar quantization factor blocks.

Video compression applies mathematical transformation, quantization, and encoding to reduce redundancies within a video sequence. International standards such as H.263, MPEG-1, MPEG-2 and MPEG-4 provide for a syntax for compressing a video sequence or source video.

A key process in video compression is quantization. It controls the rate of coded video data by adjusting quantization factors from frame to frame. The quantization factors are determined through rate control process during encoding. Many factors contribute to the final values of these step sizes. However, the ultimate contributing factor is the complexity of a video frame. Such complexity comprises the contents, or objects, and their motions. To ensure the proper buffer flow of an encoder, a bigger quantization factor is used to reduce the number of coding bits needed for a more complicated frame, and a smaller quantization factor to accommodate a less complicated frame. When a video sequence is compressed or coded, the compressed data is stored in a memory generally referred to as a bitstream file.

Obtaining certain information from a bitstream file is achieved through a process called bitstream parsing. A parsing process can provide specific information from a bitstream while leaving other information untouched. There are a few differences between a bitstream parsing process and a decoding or decompression process. Firstly, a bitstream parser does not have to obtain all information in the bitstream, while a decoder has to do so. Secondly, a decoder has to ‘decode’ or reconstruct the information obtained from the bitstream to recover the image or video sequence encoded, while a parser may not need to process the obtained specific information at all. Therefore, when display of a video sequence is not needed or not feasible, parsing a bitstream file to get specific information about a video file is desired. This, in turn, will save a tremendous amount of time for a user to pin-point suspicious video segments in a speed fashion by eliminating unnecessary decoding or reconstructing processes.

In H.263 based encoding systems, a target bit rate for an encoding frame is normally a function of target frame rate, the coding bit rate, and the quantization factors. To maintain proper buffer flow for the system, a rate control process adjusts the number of bits per coded frame by regulating the number of transform coefficients. This is achieved through quantization factor selection. The quantization factor is updated for each macroblock of a coded frame, and an average quantization factor of the frame is also calculated. This average quantization value is stored and used for bit rate calculation of the next frame.

A change in the quantization factor can be determined by assessing a present value Tᵢ and a previous value Tᵢ₋₁ to evaluate a percentage as follows:

% change=(Tᵢ−Tᵢ₋₁)/Tᵢ (4)

where Tᵢ is obtained through an ALU operation defined above in equation (3).

A motion is detected if the change is preferably above about 20% for an exemplary bit rate of 64 k bits per second, although a change above between approximately 10% and 90% can be used for motion detection. The higher the bit rate of the video sequence is, the lower the change threshold should be. It is advisable to allow a user to set the value of the threshold because it depends on the application.

The motion detection approach proposed here uses this already calculated quantization factor as an indicator of overall object motions of a coded video frame. To measure the change of motions over time, a difference value of a weighted sum of quantization factors at two adjacent frames is calculated.

Let Tᵢ represent the weighted sum of quantization factors at coded frame i, the difference between two consecutive frames i and i-1 can be expressed as

Δ=Tᵢ−Tᵢ₋₁ (5)

Let T_{q} represent a threshold value for Δ, then the frame i is considered a ‘suspicious’ frame when the following is true:

Δ≧T_{q} (6)

T_{q} is empirically designed. For instance, it can be set as an absolute difference value such as 4, 5, 6.

To prove the validity of the proposed approach, a more sophisticated method of calculating overall object motions of a coded video frame is examined and the results from both methods are compared. The more sophisticated method uses motion vectors of a coded frame and derived an average motion index value for that frame. The following is a brief description of this method.

During motion estimation process of video encoding, a motion vector is calculated as the difference between corresponding macroblocks from adjacent frames. The motion vector is stored and used for reconstructing a corresponding macroblock during decoding.

Let MVᵢ represent the motion vector of macroblock i, N represent the number of macroblocks in each frame, then

$$M = \frac{{\sum }_{i = 1}^{N} ‖ {MV}_{i} ‖}{N} \qquad ( 7 )$$

indicates the average magnitude of motion vectors of the frame. ∥MV₁∥ represents the magnitude of motion vector MVᵢ. As demonstrated by the conducted experiments, M is also a good estimate of the overall motion of the frame. This provides a fairly accurate indication of the total motion inside a video frame.

The motion detection approaches include storing all information to a file in real-time during the encoding process or parsing the video sequence after video has been recorded, using quantization factor as the motion indicator. Parsing for the quantization factor is very quick, providing essentially real-time feedback to a user. A compromise between the these two approaches is to store the quantization factor on some interval, letting the details in between the stored intervals be calculated on the fly when the user requests the information. This saves file storage and still allows fast access.

The present motion detection invention is applicable to when users have limited time to review a large amount of recorded data or when video encoding and displaying is taking place during a live video session where very limited time is allowed to provide extra motion information.

The invention is applicable to the area of motion detections for security and video surveillance applications.

The disclosed invention offers key benefits in a variety of applications. For security applications, it is beneficial to be able to trigger an event if motion is detected in the field of view. This allows an alarm to be triggered or the video to be saved if motion is detected. The motion detection would indicate an intruder has entered the premises or an event (e.g. a door opening) has occurred. This motion detection needs to be incorporated in real-time. There are a variety of devices that currently offer motion detection of real-time events. These include implementations using radar, sonar, and video. However, offering motion detection of pre-compressed data without the need for extra equipment has the advantages of lower cost, better integration, and the ability to use any existing camera.

In a similar vein, the ability to chart the motion of captured video over time allows the viewer to quickly find those events of interest. Captured video over days or weeks of time results in large amounts of data. The data cannot be reviewed in real-time, as that would take days or weeks, and therefore some means of quickly finding those events of interest is needed. The motion charting over time provides this needed means.

Although the invention has been described and illustrated in the above description and drawings, it is understood that this description is by example only, and that numerous changes and modifications can be made by those skilled in the art without departing from the true spirit and scope of the invention. Although the examples in the drawings depict only example constructions and embodiments, alternate embodiments are available given the teachings of the present, as described above, such as, for example, motion can be detected through using motion vectors instead of a quantization factor, however, its calculations will be more extensive.

What is claimed is:

1. An apparatus for motion detection on a compressed video sequence, comprising:
a receiver for locating command data from the compressed video sequence; and
a detector for detecting a change in the command data to indicate motion.

2. An apparatus for motion detection according to claim 1,
wherein the compressed video sequence received by the receiver has predetermined compressed format; and
wherein the receiver locates the command data from the compressed video sequence by obtaining synchronization information to locate known position in the video sequence and by parsing the compressed video sequence until finding the desired command data field.

3. An apparatus for motion detection according to claim 1,
wherein the command data located by the receiver comprises a quantization factor of the compressed video sequence; and
wherein the detector detects change in the quantization factor to indicate motion.

4. An apparatus for motion detection according to claim 3, wherein the compressed video sequence received by the receiver comprises frames of digital command data and of image data.

5. An apparatus for motion detection according to claim 4, wherein the compressed video sequence received by the receiver has a constant number of bits per frame.

6. An apparatus for motion detection according to claim 3, wherein the detector detects change in the quantization factor by assessing an amount of change of a present value Tᵢ and a previous value Tᵢ₋₁ as follows:
amount of change=(Tᵢ−Tᵢ₋₁)/Tᵢ
and wherein the amount of change is threshold to indicate motion.

7. An apparatus for motion detection according to claim 6, wherein the detector detects an amount of change by thresholding to indicate motion when the amount of quantization factor change is above about 20%.

8. An apparatus for motion detection according to claim 6, wherein the detector detects an amount of change by thresholding to indicate motion when the amount of quantization factor change is above between approximately 10% and 90%.

9. An apparatus for motion detection according to claim 3, wherein the detector detects an amount of change in the quantization factor by taking a derivative of the quantization factor to assess an amount of change and indicate motion.

10. An apparatus for motion detection according to claim 3, wherein the compressed video sequence received by the receiver comprises an MPEG compressed video sequence.

11. An apparatus for motion detection according to claim 3, wherein the compressed video sequence received by the receiver comprises an H.263 compressed video sequence.

12. An apparatus for motion detection according to claim 11, wherein the command data located by the receiver comprises a PQUANT quantization factor field of the H.263 compressed video sequence.

13. An apparatus for motion detection according to claim 1, wherein both the receiver and the detector operate in real time on the compressed video sequence.

14. A method of motion detection on a compressed video sequence, comprising the steps of:
(a) locating command data from the compressed video sequence; and
(b) detecting a change in the command data to indicate motion.

15. A method of motion detection according to claim 14,
wherein the video sequence used in step (a) has predetermined format; and
wherein the receiving of said step (a) comprises the substeps of
(a1) obtaining synchronization information to locate known position in the video sequence; and
(a2) parsing the compressed video sequence until finding the desired command data field.

16. A method of motion detection according to claim 14,
wherein the command data located in step (a) comprises a quantization factor of the compressed video sequence; and
wherein the detecting step (b) comprises the substep of (b1) detecting change in the quantization factor to indicate motion.

17. A method of motion detection according to claim 16, wherein the compressed video sequence used in step (a) comprises frames of digital command data and of image data.

18. A method of motion detection according to claim 17, wherein the compressed video sequence used in step (a) has a constant number of bits per frame.

19. A method of motion detection according to claim 16, wherein the step (b1) of determining change in the quantization factor comprises the substep of (b1i) taking a derivative of the quantization factor to assess an amount of change and indicate motion.

20. A method of motion detection according to claim 14, wherein both the steps (a) and (b) operate in real time on the compressed video sequence.
